(19) United States
(12) Patent Application Publication
(10) Pub. No.: US 2023/0131217 A1
(43) Pub. Date: Apr. 27, 2023

(54) METHODS OF ADJUSTING A POSITION OF IMAGES, VIDEO, AND/OR TEXT ON A DISPLAY SCREEN OF A MOBILE ROBOT

(71) Applicant: Blue Ocean Robotics Aps, Odense (DK)

(72) Inventors: Rasmus Vistisen, Odense (DK); John Erland Østergaard, Odense (DK); Efraim Vitzrabin, Odense (DK); Peter Juhl Voldsgaard, Odense (DK)

(21) Appl. No.: 17/507,515

(22) Filed: Oct. 21, 2021

(51) Int. Cl. H04N 7/18; G05D 1/02; G05D 1/00; G06K 9/00; H04N 7/14; H04N 5/262; H04N 5/268; H04N 5/278

(52) U.S. Cl. CPC H04N 7/185; G05D 1/0285; G05D 1/0038; G06K 9/00671; H04N 7/147; H04N 5/2628; H04N 5/268; H04N 5/278

(57) ABSTRACT

Implementations of the disclosed subject matter provide a mobile robot that moves within an area and captures image data by an image sensor. A position of text, an image, and/or video on a display screen of a display mounted to the mobile robot may be adjusted based on the image data captured by the mobile robot that includes one or more persons that are within the area. The text, the image, and/or the video may be at the adjusted position in the display screen of the display and audio via a speaker of the mobile robot to the one or more persons based on their heights, eye level, whether they are seated, or the like.

### BACKGROUND

Current telepresence robots typically include a camera, a display, a microphone, and a drive system. Telepresence robots help telecommuters, doctors, remote workers, students, and other professionals to feel more connected to colleagues or other persons by giving them a physical presence when they cannot be present in-person. Telepresence robots are typically remotely driven by a user so that the robot may move about an office, educational setting, workplace, or the like.

### BRIEF SUMMARY

According to an implementation of the disclosed subject matter, a method may include receiving, at a mobile robot, one or more first control signals via a communications interface to control a drive system of the mobile robot to move within an area in a first operation mode. Image data captured by an image sensor of the mobile robot may be transmitted via the communications interface. The mobile robot may receive one or more second control signals via the communications interface to operate in a second mode to stop the movement of the mobile robot. The method may include adjusting, at a controller of the mobile robot based on the one or more third control signals received via the communications interface, a position of at least one of text, an image, and/or video on a display screen of a display mounted to the mobile robot based on the captured image data when the captured image data includes one or more persons within the area. The at least one of the text, the image, and/or the video may be output at the adjusted position in the display screen of the display and audio via a speaker of the mobile robot to the one or more persons.

According to an implementation of the disclosed subject matter, a method may include receiving, at a mobile robot, one or more first control signals via a communications interface to control a drive system of the mobile robot to move within an area in a first operation mode. A controller of the mobile robot may determine when there are one or more persons in the area using an image sensor communicatively coupled to the controller. The controller of the mobile robot may control the drive system to stop the movement of the mobile robot within a predetermined distance of the one or more persons. The method may include adjusting, at a controller of the mobile robot, a position of at least one of text, an image, and/or video on a display screen of a display mounted to the mobile robot based on the captured image data when the captured image data includes one or more persons that are within the area. The text, the image, and/or the video may be output at the adjusted position in the display screen of the display and audio via a speaker of the mobile robot to the one or more persons.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIGS. 1-5 show an example method of controlling a movement of a mobile robot and receiving control signals to adjust a position of a display screen in a display according to implementations of the disclosed subject matter.

FIGS. 6-10 show another example method of controlling a movement of the mobile robot, where the mobile robot adjusts a position of a display screen rather than receiving commands from a remote device as in FIGS. 1-5, according to an implementation of the disclosed subject matter.

FIGS. 11-12 show an example mobile robot according to an implementation of the disclosed subject matter.

FIG. 13 shows movement of the mobile robot and adjustment of a display screen according to an implementation of the disclosed subject matter.

FIGS. 14-16 show example display screens of the mobile robot according implementations of the disclosed subject matter.

FIG. 17 shows an example configuration of the mobile robot of FIGS. 11-12 according to an implementation of the disclosed subject matter.

FIG. 18 shows a network configuration which may include a plurality of mobile robots according to implementations of the disclosed subject matter.

### DETAILED DESCRIPTION

Implementations of the disclosed subject matter provide a telepresence mobile robot that adjusts a position of an image, video, and/or text that is displayed in a display screen of a mobile robot to make it more viewable to one or more persons that the mobile robot is communicating with via the display screen. The persons may have different heights from one another, and/or may be seated. The image, video, and/or text may be positioned, for example, at a top portion or a bottom portion of a screen. That is, implementations of the disclosed subject matter improve upon current telepresence robots by adjusting the image, video, and/or text in a display. Current telepresence robots typically have a display mounted on a shaft, where the shaft is manually adjustable to change a height of a display, or have a display that is rotatable about an axis, so that the display can be tilted up or down.

In implementations of the disclosed subject matter, adjustment of the image, video, and/or text may be based on a detected height of the one or more persons, and/or an average eye height or lowest eye height of one or more persons that are within a predetermined distance from the mobile robot. This adjustment may accommodate persons of different height, and/or may be seated. The image, video, and/or text may be rescaled when the position of the image, video, and/or text is adjusted.

The adjustments may increase the visibility of the image, video, and/or text for the one or more persons to view the display screen of the mobile robot. That is, by adjusting the image, video, and/or text displayed on the display screen, the one or more persons that may have different heights and/or may be seated may feel more present with a person whose image is displayed on the display screen. The adjustment of the image on the display screen of a remote person may allow for eye-to-eye contact with the one or more persons. Such eye contact may be beneficial in providing a sense of presence with the remote person. For example, the image, video, and/or text may be adjusted to match the height of the one or more persons in an area, such as when the persons are seated. In some implementations, the user (i.e., pilot) of the mobile robot may adjust the image, video, and/or text on the screen by transmitting control signals to the mobile robot. In some implementations, the mobile robot may control the adjustment of the image, video, and/or text displayed on the display screen.

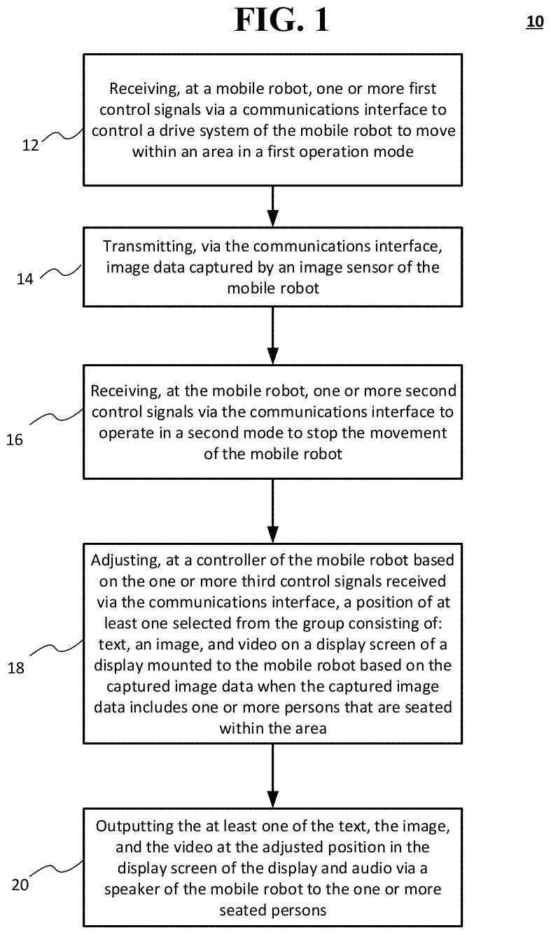

FIGS. 1-5 show an example method 10 of controlling a movement of a mobile robot and receiving control signals to adjust a position of a display screen in a display according to implementations of the disclosed subject matter. That is, in method 10, a remote pilot controls the adjustment of the display screen by transmitting control signals to the mobile robot from a remote user device.

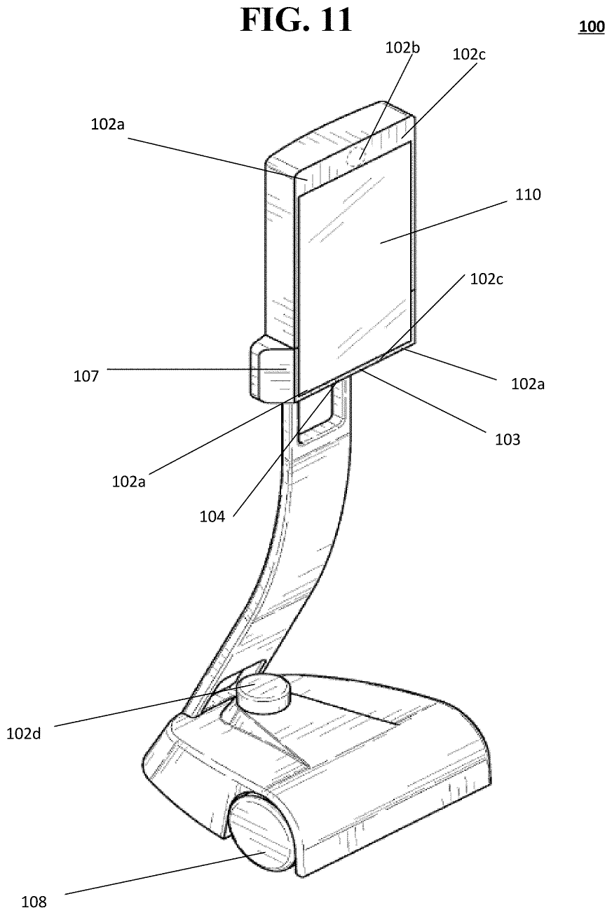

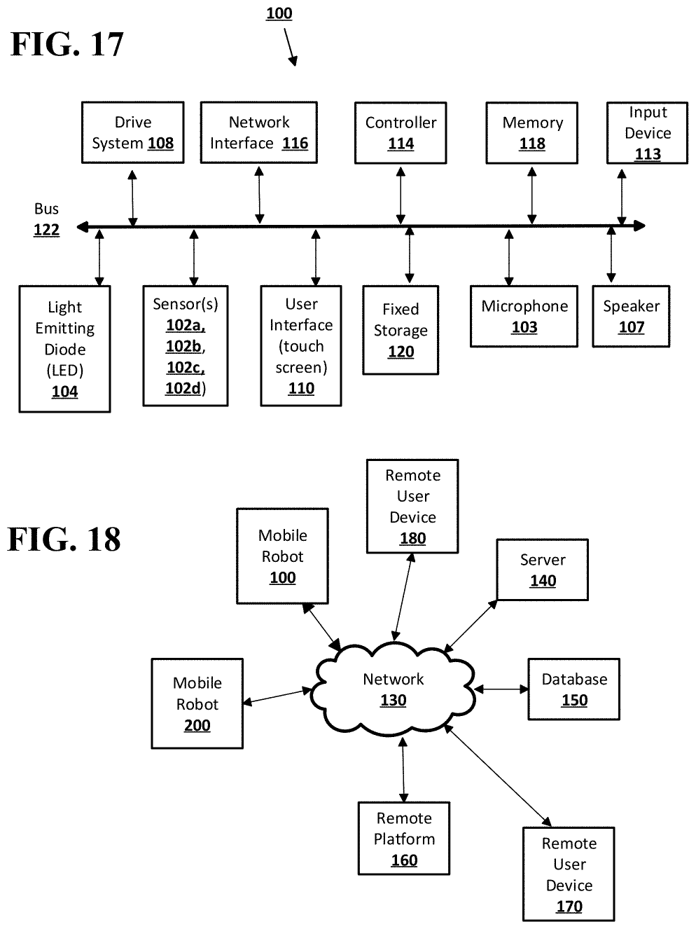

At operation 12, a mobile robot (e.g., mobile robot 100 shown in FIGS. 11-12 and 17) may receive one or more first control signals via a communications interface (e.g., network interface 116 shown in FIG. 17) to control a drive system (e.g., drive system 108 shown in FIGS. 11, 12, and 17) of the mobile robot to move within an area in a first operation mode. The area may be a room, a building, an indoor area, an outdoor area, or the like. In some implementations, the mobile robot may receive the first control signals via network 130 from remote user device 170 and/or 180 as shown in FIG. 18. In some implementations, the controller (e.g., controller 144 shown in FIG. 17) may control the drive system to move the robot to the area based on the received first control signals.

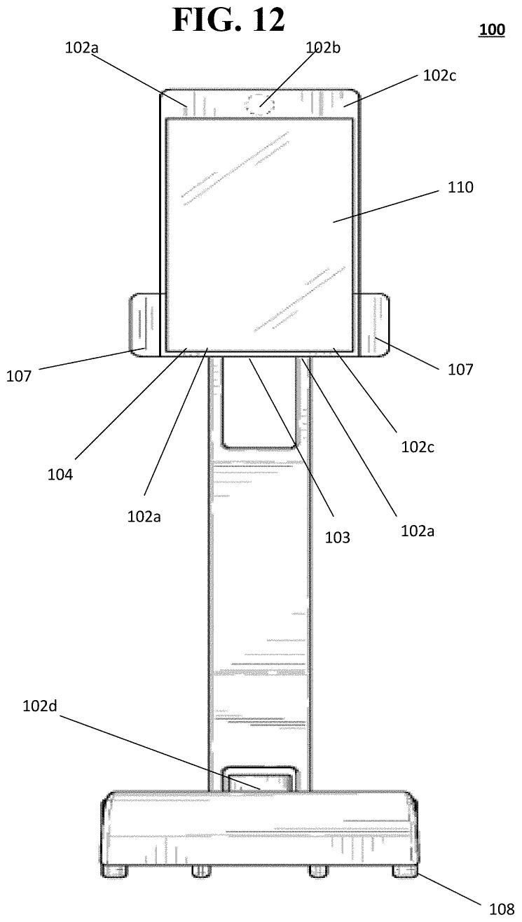

At operation 14, the communications interface of the mobile robot may transmit image data captured by an image sensor (e.g., sensor 102a, 102b, 102c, and/or 102d shown in FIGS. 11-12) of the mobile robot. The image data may be transmitted, for example, via network 130 shown in FIG. 18 to a server 140, a remote platform 160, a remote user device 170 and/or 180, or the like. The image data may be viewed by a user (i.e., a pilot) that controls the mobile robot in order to determine control commands to transmit to the mobile robot to move within the area. That is, when viewing the captured images, the user may transmit the one or more first control signals to control the movement of the mobile robot (e.g., using the remote platform 160, and/or remote user device 170, 180).

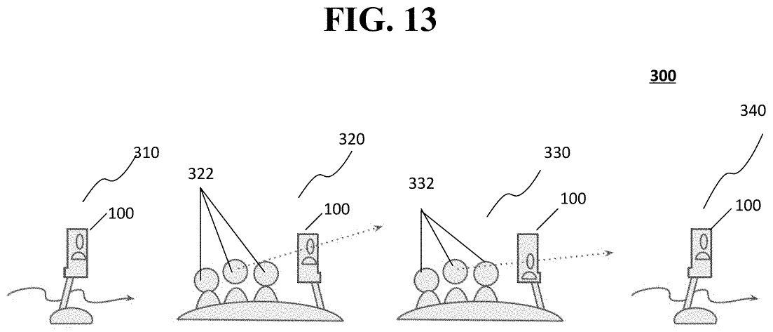

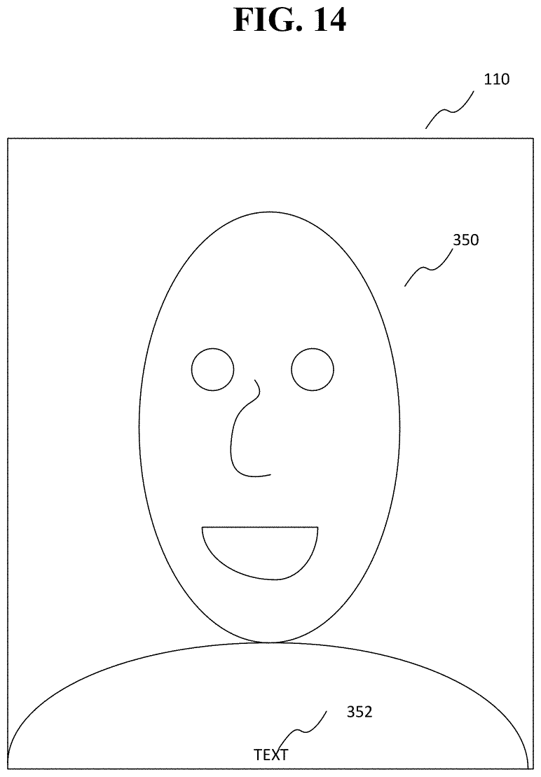

At operation 16, the mobile robot may receive one or more second control signals via the communications interface (e.g., network interface 116 shown in FIG. 17) to operate in a second mode to stop the movement of the mobile robot. For example, the mobile robot may receive the second control signals to stop movement when the image sensor (e.g., sensor 102a, 102b, 102c, and/or 102d shown in FIGS. 11-12) captures an image of one or more persons (e.g., persons 322, 332 shown in FIG. 13 that may be seated and/or may have different heights). In some implementations, the captured image of the one or more persons may be transmitted via the communications interface to remote platform (e.g., remote platform 160 shown in FIG. 18) and/or a remote user device (e.g., remote user device 170, 180 shown in FIG. 18). The remote platform and/or the remote user device may transmit the one or more second control signals to the mobile robot so that the mobile robot may operate in a second mode that stops movement of the mobile robot. The movement stoppage may occur so that the mobile robot may output images, video, and/or text via a display screen on a display (e.g., user interface 110 shown in FIGS. 11, 12, and 17), and/or output audio via a speaker (e.g., speaker 107 shown in FIGS. 11, 12, and 17).

Based on one or more third control signals received via the communications interface, a controller (e.g., controller 114 shown in FIG. 17) of the mobile robot may adjust a position of at least one of text, an image, and/or video on a display screen of a display (e.g., user interface 110 shown in FIGS. 11, 12, and 14-17) mounted to the mobile robot at operation 18. The position may be adjusted based on the captured image data that includes one or more persons (e.g., persons 322, 332 shown in FIG. 13) that are within the area, and/or based on the control signals received from remote user device 170 and/or 180 as shown in FIG. 18 and/or via a command received via the user interface 110 of the mobile robot 100 shown in FIGS. 11, 12, and 17 from an operator or person that is present with the mobile robot 100.

In some implementations, operation 18 may include adjusting the position of the text, the image, and/or the video based on an average eye height of the one or more persons in the captured image data. The persons may have different heights, may be seated, or the like. The image sensor (e.g., sensor 102a, 102b, 102c, and/or 102d shown in FIGS. 11-12) of the mobile robot may determine the location of the eyes of the one or more persons (e.g., persons 322, 332 shown in FIG. 13). The height of the eyes may be determined based on the location of the eyes and a reference point, such as a floor or other surface in the area. The controller of the mobile robot, a remote platform and/or, a remote user device may determine an average eye height based on the determined height of the eyes for each of the one or more persons. The position of the text, the image, and/or the video in the display screen may be based on the determined average height of the eyes of the one or more persons. Control signals that are received by the mobile robot from a remote platform and/or remote user device may adjust the position based on the determined average height of the eyes.

In some implementations, operation 18 may include adjusting, at the controller based on the one or more third control signals, the position of the at least one of the text, the image, and/or the video in the display screen based on a lowest eye height of the one or more persons in the captured image data. The persons may have different heights, and/or may be seated. For example, the image sensor (e.g., sensor 102a, 102b, 102c, and/or 102d shown in FIGS. 11-12) may determine the location of the eyes of the one or more persons (e.g., persons 322, 332 shown in FIG. 13). The height of the eyes may be determined based on the location of the eyes and a reference point, such as a floor or other surface in the area. The controller of the mobile robot, a remote platform and/or, a remote user device may determine the lowest height based on the determined height of the eyes for each of the one or more persons. The position of the text, the image, and/or the video may be adjusted in the display screen based on the determined lowest height of the eyes of a person in a group of the one or more persons. Control signals that are received by the mobile robot from a remote platform and/or remote user device may adjust the position based on the determined lowest height of the eyes.

In some implementations, operation 18 of FIG. 1 may include rescaling the at least one of the text, the image, and/or the video based on the one or more third control signals received by the communications interface of the mobile robot. That is, the text, the image, and/or the video may be rescaled when the position of the at least one text, image and/or the video in the display screen is adjusted. The rescaling may include changing the size, resolution, or the like of the text, image, and/or video.

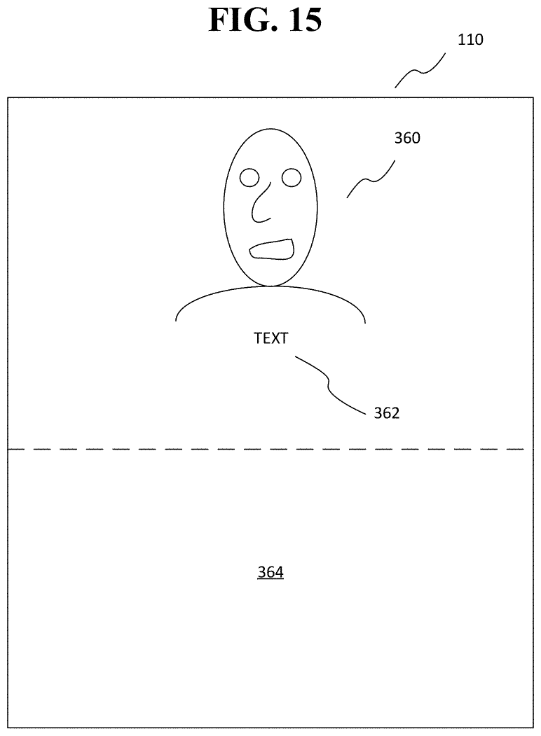

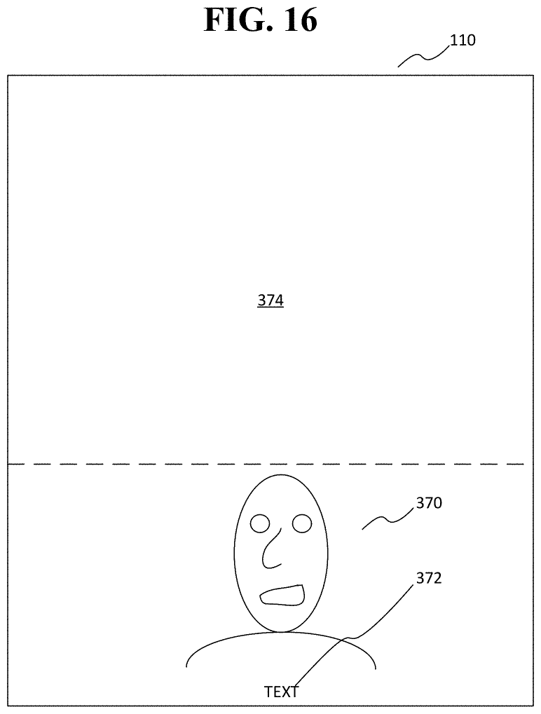

In yet another implementation, operation 18 may include blocking or masking a portion of the display screen of the display that is separate from the position where the at least one of the text, the image, and the video is being displayed. For example, FIG. 15 shows an image and/or video 360 and the text 362 have been adjusted to be at the top portion of the display screen, and that the bottom portion of the display screen has been blocked off by block 364. In another example, FIG. 16 shows an image and/or video 370 and text 372 that has been adjusted to a bottom portion of the display screen, with block 374 placed in the upper portion of the display screen to block off this portion of the display screen. The blocking or masking may be useful in directing the gaze of the one or more persons to the portion of the display screen that includes the adjusted position of the image, video, and/or text.

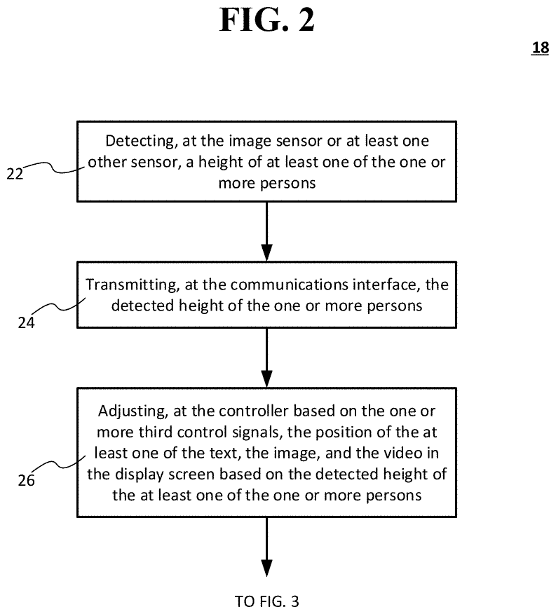

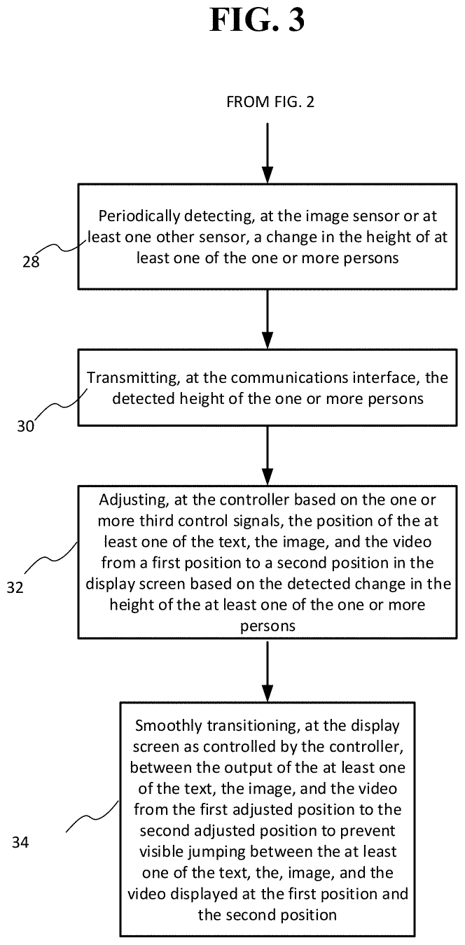

Other implementations of the disclosed subject matter that provide optional operations for operation 18 of FIG. 1 are shown in FIGS. 2, 3, and 5, and described in detail below.

At operation 20, the text, the image, and/or the video may be output at the adjusted position in the display screen of the display (e.g., user interface 110 shown in FIGS. 11, 12, and 14-17) to the one or more persons. Audio may be output to the one or more persons via a speaker (e.g., speaker 107 shown in FIGS. 11, 12, and 17) disposed on the mobile robot.

In some implementations, the method 10 may include receiving, at a mobile robot, one or more third control signals via the communications interface (e.g., e.g., network interface 116 shown in FIG. 17) to control the drive system (e.g., drive system 108 shown in FIGS. 11-12 and 17) of the mobile robot to move within the area in the first operation mode when the outputting the at least one of the text, the image, and the video is completed. That is, when communication between a user of the mobile robot (e.g., a pilot) and the one or more persons is completed, the mobile robot may receive control signals to move the mobile robot.

FIG. 2 may show example operations that may be performed in connection with operation 18 of FIG. 1 according to implementations of the disclosed subject matter. At operation 22, the image sensor and/or at least one other sensor (e.g., sensors 102a, 102b, 102c, 102d shown in FIGS. 11, 12, and 17) may be used to detect a height of at least one of the one or more persons (e.g., persons 322, 332 shown in FIG. 13). At operation 24, the communications interface of the mobile robot may transmit the detected height of the one or more persons. For example, the mobile robot may transmit the detected height to a remote platform 160 and/or remote user device 170, 180 shown in FIG. 18. Based on the one or more third control signals received by the mobile robot from the remote platform and/or remote user device 170, 180, the controller of the mobile robot may adjust the position of the at least one of the text, the image, and/or the video in the display screen based on the detected height of the at least one of the one or more persons at operation 26.

FIG. 3 shows additional example operations that may be performed, for example, after operation 26 of FIG. 2 according to implementations of the disclosed subject matter. At operation 28, the image sensor and/or at least one other sensor (e.g., sensors 102a, 102b, 102c, 102d shown in FIGS. 11, 12, and 17) may periodically detect a change in the height of at least one of the one or more persons (e.g., persons 322, 332 shown in FIG. 13). At operation 30, the communications interface of the mobile robot may transmit the detected height of the one or more persons to, for example, the remote platform 160 and/or the remote user device 170, 180. Based on the one or more third control signals, the controller may adjust the position of the text, the image, and/or the video from a first position to a second position in the display screen at operation 32 based on the detected change in the height of the at least one of the one or more persons. For example, the change in height may be detected when one person moves from a seated position to a standing position. The first position may have the image, video, and/or text fill the display screen, as shown in FIG. 14, and the second position may display the image, video, and/or text at the top portion (e.g., as shown in FIG. 15) or the bottom portion (e.g., as shown in FIG. 16) of the display screens.

In some implementations, operation 32 may include operation 34, where the controller may control the display screen to smoothly transition between the output the text, the image, and/or the video from the first adjusted position to the second adjusted position to prevent visible jumping between the text, the image, and/or the video displayed at the first position and the second position.

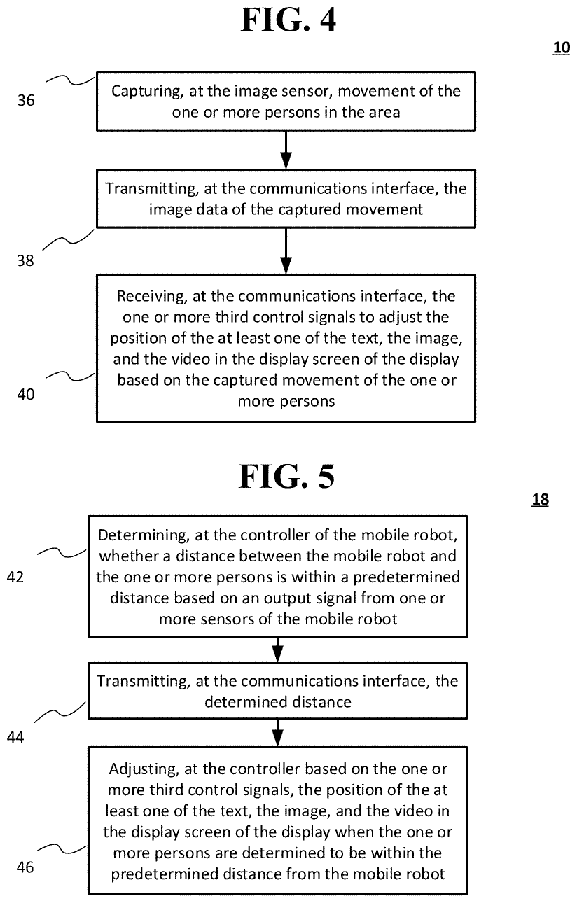

FIG. 4 shows optional additional operations of method 10 according to an implementation of the disclosed subject matter. At operation 36, an image sensor (e.g., sensor 102a, 102b, 102c, and/or 102d shown in FIGS. 11, 12, and 17) may capture the movement of the one or more persons that may be in the area. For example, one or more of the persons may be moving while seated (e.g., moving their position relative to the mobile robot by moving the chair that they are seated in), may be moving from a standing position to a seated position, or moving from a seated position to a standing position. At operation 38, the communications interface (e.g., network interface 116 shown in FIG. 17) of the mobile robot may transmit the image data of the captured movement. For example, the mobile robot may transmit the captured image data via network 130 to remote platform 160, remote user device 170, and/or remote user device 180. At operation 140, the communications interface of the mobile robot may receive the one or more third control signals (e.g., from the remote platform 160, remote user device 170, and/or remote user device 180) to adjust the position of the at least one of the text, the image, and the video in the display screen of the display based on the captured movement of the one or more persons.

FIG. 5 shows example additional operations of operation 18 of FIG. 1 of the adjusting the position of the at least one of the text, the image, and/or the video in the display screen according to an implementation of the disclosed subject matter. At operation 42, the controller (e.g., controller 114 shown in FIG. 17) of the mobile robot may determine whether a distance between the mobile robot and the one or more persons (e.g., persons 322, 332 shown in FIG. 13) is within a predetermined distance based on an output signal from one or more sensors (e.g., sensor 102a, 102b, 102c, 102d) of the mobile robot (e.g., mobile robot 100 shown in FIGS. 11-13, 17, and 18). At operation 44, the communications interface of the mobile robot device may transmit the determined distance. For example, the communications interface may transmit the determined distance to the remote platform 160, the remote user device 170 and/or the remote user device 180 via the network 130 shown in FIG. 18. The controller may adjust, based on the one or more third control signals (e.g., received from the remote platform 160 and or remote user device 170, 180), the position of the text, the image, and/or the video in the display screen of the display when the one or more persons are determined to be within the predetermined distance from the mobile robot at operation 46. For example, the controller may adjust the image and/or video 350, and/or text 352 shown in FIG. 14 to a top portion of the display screen as shown in FIG. 15 (e.g., image and/or video 360, and/or text 362 as shown in the top portion of the display screen). In another example, the image, video, and/or text may be moved to a bottom portion of the display screen as shown in FIG. 16 (e.g., image and/or video 370, and/or text 372 as shown in the bottom portion of the display screen).

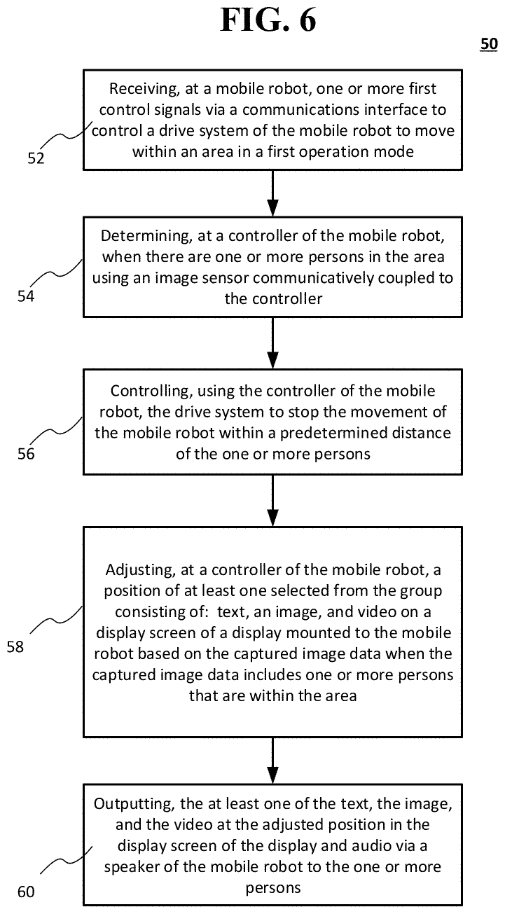

FIGS. 6-10 show another example method 50 of controlling a movement of the mobile robot, where the mobile robot adjusts a position of a display screen, rather than commands from a remote device as in FIGS. 1-5, according to an implementation of the disclosed subject matter. At operation 52, the mobile robot may receive one or more first control signals via a communications interface (e.g., network interface 116 shown in FIG. 17) to control a drive system (e.g., drive system 108 shown in FIG. 17) of the mobile robot to move within an area in a first operation mode.

At operation 54, the controller of the mobile robot may determine when there are one or more persons in the area using an image sensor (e.g., sensor 102a, 102b, 102c, and/or 102d shown in FIGS. 11, 12, and 17) communicatively coupled to the controller (e.g., controller 114 shown in FIG. 17). That is, the image sensor may capture images of the area, and determine whether there are one or more persons within the captured images. For example, the image sensor may capture images of the persons within the area that are seated, standing, or the like.

At operation 56, the controller of the mobile robot may control the drive system to stop the movement of the mobile robot within a predetermined distance of the one or more persons. For example, as shown in FIG. 13, the mobile robot 100 may be stopped at a predetermined distance from one or more persons 322, 332. The movement stoppage may occur so that the mobile robot may output images, video, and/or text via a display screen on a display (e.g., user interface 110 shown in FIGS. 11, 12, and 17), and/or output audio via a speaker (e.g., speaker 107 shown in FIGS. 11, 12, and 17).

The controller of the mobile robot may adjust a position of at least one of text, an image, and/or video on a display screen of a display mounted to the mobile robot at operation 58 based on the captured image data when the captured image data includes one or more persons that are within the area (e.g., one or more persons 322, 332 shown in FIG. 13). In contrast to operation 18 of FIG. 1, the mobile robot may adjust the position of the image, video, and/or text at operation 58 without receiving control signals from a remote platform and/or remote user device.

In some implementations, the controller (e.g., controller 114 shown in FIG. 17) of the mobile robot may adjust the position of the text, the image, and/or the video based on an average eye height of the one or more persons (e.g., persons 322, 332 shown in FIG. 13) in the captured image data at operation 58. The average height may be determined in the same or similar manner as discussed above in connection with operation 18 of FIG. 1. The average height may be determined for the persons that are standing and/or seated.

In some implementations, the controller may adjust the position of the text, the image, and/or the video in the display screen based on a lowest eye height of the one or more persons (e.g., persons 322, 332 shown in FIG. 13) in the captured image data at operation 58. The persons may be seated and/or standing. The lowest eye height may be determined in the same or similar manner as discussed above in connection with operation 18 of FIG. 1.

In some implementations, the controller may adjust the position of the text, the image, and/or the video in the display screen by rescaling. The rescaling may include changing the size resolution, or the like of the text, image, and/or video.

In some implementations, the controller may adjust the position of the at least one of the text, the image, and the video in the display screen by blocking or masking a portion of the display screen of the display that is separate from the position where the at least one of the text, the image, and the video is being displayed. For example, FIG. 15 shows an image and/or video 360 and the text 362 have been adjusted to be at the top portion of the display screen, and that the bottom portion of the display screen has been blocked off by block 364. In another example, FIG. 16 shows an image and/or video 370 and text 372 that has been adjusted to a bottom portion of the display screen, with block 374 placed in the upper portion of the display screen to block off this portion of the display screen.

At operation 60, the at least one of the text, the image, and/or the video may be output at the adjusted position in the display screen of the display to the one or more persons. Audio may be output via a speaker (e.g., speaker 107 shown in FIGS. 11-12, and 17) of the mobile robot to the one or more persons. The blocking may be useful in directing the gaze of the one or more persons (e.g., that may be seated, standing, or the like) to the portion of the display screen that includes the adjusted position of the image, video, and/or text.

In some implementations, the mobile robot may receive one or more third control signals via the communications interface to control the drive system of the mobile robot to move within the area in the first operation mode when the outputting of the text, the image, and/or the video is completed.

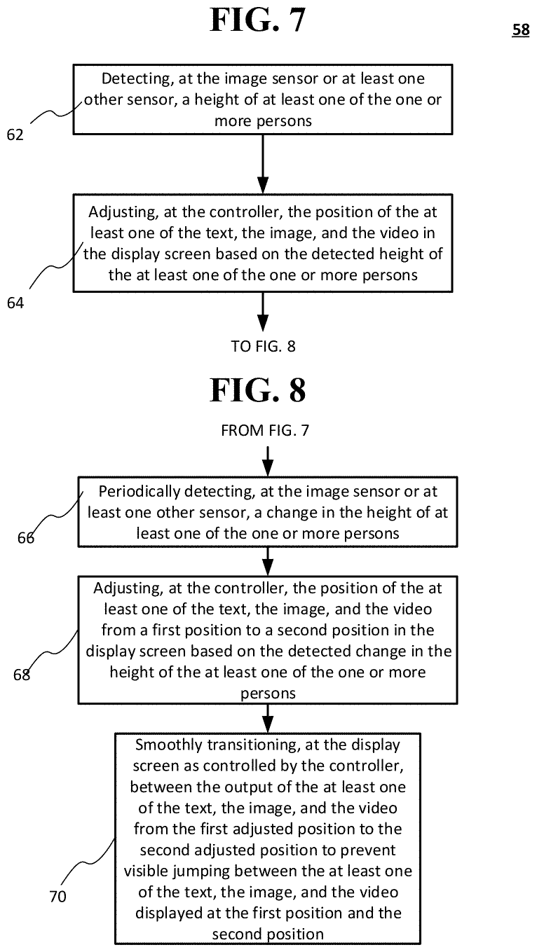

FIG. 7 shows example additional operations that may be performed at operation 58 of FIG. 6 in adjusting the position of text, the image, and/or the video in the display screen according to implementations of the disclosed subject matter. At operation 62, the image sensor or at least one other sensor (e.g., sensor 102a, 102b, 102c, and/or 102d shown in FIGS. 11-12) may detect a height of at least one of the one or more persons (e.g., persons 322, 332 shown in FIG. 13). At operation 64, the controller (e.g., controller 114 shown in FIG. 17) of the mobile robot may adjust the position of the text, the image, and/or the video in the display screen based on the detected height of the at least one of the one or more persons.

FIG. 8 shows additional operations that may be performed, for example, after the operations shown in FIG. 7 according to an implementation of the disclosed subject matter. At operation 66, the image sensor or at least one other sensor may periodically detect a change in the height of at least one of the one or more persons (e.g., persons 322, 332 shown in FIG. 13). At operation 68, the controller of the mobile robot may adjust the position of the text, the image, and/or the video from a first position to a second position in the display screen based on the detected change in the height of the at least one of the one or more persons. For example, the image and/or video 360 and text 362 may positioned at a top portion of the display screen as shown in FIG. 15 (i.e., a first position), and may be adjusted to be positioned at the bottom portion of the display screen (i.e., at the second position) based on the detected change in height. Operation 68 may optionally include the operation 70, where the display screen as controlled by the controller may smoothly transition between the output of the text, the image, and/or the video from the first adjusted position to the second adjusted position to prevent visible jumping between the text, the image, and/or the video displayed at the first position and the second position (e.g., from the top portion to the bottom portion of the display screen, or from the bottom to the bottom portion of the display to the top portion of the display, as shown in FIGS. 15-16).

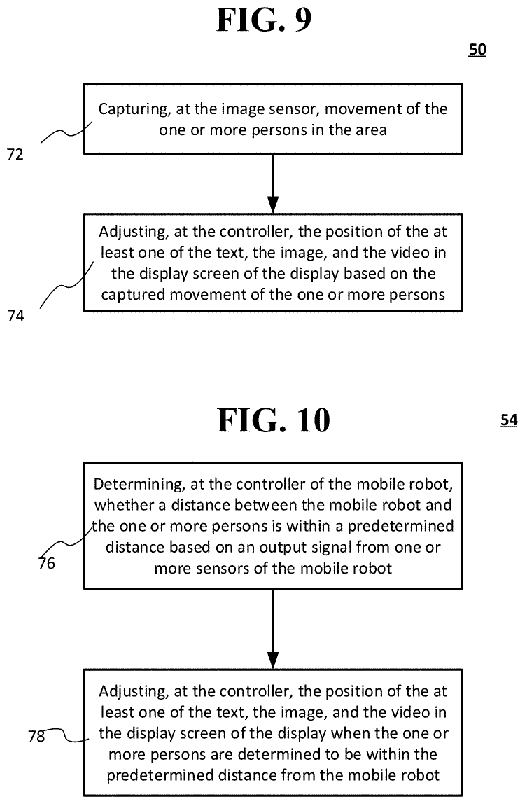

FIG. 9 shows additional example operations of method 50 according to an implementation of the disclosed subject matter. At operation 72, the image sensor (e.g., sensor 102a, 102b, 102c, 102d shown in FIGS. 11, 12, and 17) may capture movement of the one or more persons in the area (e.g., persons 322, 332 shown in FIG. 13). At operation 74, the controller may adjust the position of the text, the image, and/or the video in the display screen of the display based on the captured movement of the one or more persons. For example, the image and/or video 350 and text 352 shown in FIG. 14 may be adjusted as shown in FIG. 15, where the image and/or video 360 and the text 362 is adjusted to be positioned in a top portion of a display screen.

FIG. 10 shows additional example operations for operation 54 of FIG. 6 for adjusting the position of the text, the image, and/or the video in the display screen according to an implementation of the disclosed subject matter. At operation 76, the controller of the mobile robot may determine whether a distance between the mobile robot (e.g., mobile robot 100) and the one or more persons (e.g., persons 322, 332 shown in FIG. 13) is within a predetermined distance based on an output signal from one or more sensors (e.g., sensors 102a, 102b, 102c, 102d shown in FIGS. 11, 12, and 17) of the mobile robot.

At operation 78, the controller may adjust the position of the text, the image, and/or the video in the display screen of the display when the one or more persons are determined to be within the predetermined distance from the mobile robot. For example, the controller may adjust the image and/or video 350, and/or text 352 shown in FIG. 14 to a top portion of the display screen as shown in FIG. 15 (e.g., image and/or video 360, and/or text 362 as shown in the top portion of the display screen). In another example, the image, video, and/or text may be moved to a bottom portion of the display screen as shown in FIG. 16 (e.g., image and/or video 370, and/or text 372 as shown in the bottom portion of the display screen).

Implementations FIGS. 11-12 show an example mobile robot 100 according to an implementation of the disclosed subject matter. The mobile robot 100 may have a plurality of sensors. Sensor 102a may be a time-of-flight sensor. Sensor 102b may be an RGB (a Red, Green, Blue image sensor) camera and/or image sensor, and sensor 102c may be an RGB-D (an RGB depth camera). In some implementations, sensor 102b, 102c may be a stereo vision sensor, 3D camera, an image sensor, thermal camera, a structured light camera, or the like. Sensor 102d may be a two-dimensional (2D) Light Detection and Ranging (LiDAR) sensor, a three-dimensional (3D) LiDAR sensor, and/or a radar (radio detection and ranging) sensor, ultrasonic sensor, or the like. The sensors 102a, 102b, and/or 102c may be used to control the movement of the mobile robot, and/or track the person that is being guided or followed by the mobile robot.

The mobile robot 100 may include at least one microphone 103. In some implementations, the mobile robot 100 may have a plurality of microphones 103 arranged in an array.

The mobile robot 100 may include an light emitting diode (LED), organic light emitting diode (OLED), lamp, and/or any suitable light source that may be controlled by the controller (e.g., controller 114 shown in FIG. 13) to illuminate a portion of the area for navigation of the mobile robot.

The mobile robot 100 may include a motor to drive the drive system 108 to move the mobile robot in an area, such as a room, a building, or the like. The drive system 108 may include wheels, which may be adjustable so that the drive system 108 may control the direction of the mobile robot 100.

The mobile robot 100 may include one or more speakers 107. In some implementations, such as shown in FIG. 12, speakers 107 may be disposed on first and second sides (e.g., left and right sides) of a display of a user interface 110. The user interface 110 may be an LCD (liquid Crystal Display), an LED display, an OLED display, or the like to display images, such as those received from the remote user device 170. The display of the user interface 110 may be a touch screen.

FIG. 13 shows operations 300 of the mobile robot, including movement and adjustment of a position on a display on a display screen according to implementations of the disclosed subject matter. The operations 300 may include at least some of the operations shown in FIGS. 1-10 and described above. At operation 310, the mobile robot may receive the one or more first control signals via a communications interface to control a drive system of the mobile robot to move within an area in a first operation mode, as described in connection with operation 12 shown in FIG. 1 and operation 56 shown in FIG. 6 and described above. At operation 320, the mobile robot 100 may stop to communicate with one or more sitting persons 322. For example, as described above in connection with operation 16 shown in FIG. 1 and operation 56 shown in FIG. 6, the mobile robot 100 may receive one or more second control signals via the communications interface to operate in a second mode to stop the movement of the mobile robot 100. At operation 330, the controller of the mobile robot 100 may adjust a position of the text, the image, and/or the video on the display screen of the display, as shown in operation 18 of FIG. 1 and operation 58 as shown in FIG. 6 and described above.

For example, based on the distance between the one or more persons 332 and the mobile robot 100 and/or the eye height of the one or more persons (e.g., that may be seated, standing, or the like), the position of the text, the image, and/or the video may be adjusted on the display screen of the display. The text, image, and/or video may be positioned to fill the display screen, such as shown in FIG. 14. That is, the image and/or video 350 and/or the text 352 may be adjusted to fill the display screen of the display (e.g., user interface 110). In some implementations, as shown in FIG. 15, the image and/or video 360 and/or the text 362 may be positioned at a top portion of the display screen to be viewable to the one or more persons. The bottom portion of the display screen may be optionally blocked of by block 364. In some implementations, as shown in FIG. 16, the image and/or video 370 and/or the text 372 may be positioned at a bottom portion of the display screen to be viewable to the one or more persons. The top portion of the display screen may be optionally blocked of by block 374.

FIG. 17 shows example components of the mobile robot 100 suitable for providing the implementations of the disclosed subject matter. The mobile robot 100 may include a bus 122 which interconnects major components of the mobile robot 100, such as the drive system 108, a network interface 116 operable to communicate with one or more remote devices via a suitable network connection, the controller 114, a memory 118 such as Random Access Memory (RAM), Read Only Memory (ROM), flash RAM, or the like, an input device 113 which may be any device to receive commands from a person, the LED light source 104, sensor 102a, sensor 102b, sensor 102c, sensor 102d, a user interface 110 that may include one or more controllers, a display and associated user input devices such as a touch screen, a fixed storage 120 such as a hard drive, flash storage, and the like, a microphone 103, and a speaker 107 to output an audio notification and/or other information.

The bus 122 allows data communication between the controller 114 and one or more memory components, which may include RAM, ROM, and other memory, as previously noted. Typically, RAM is the main memory into which an operating system and application programs are loaded. A ROM or flash memory component can contain, among other code, the Basic Input-Output system (BIOS) which controls basic hardware operation such as the interaction with peripheral components. Applications resident with the mobile robot 100 are generally stored on and accessed via a computer readable medium (e.g., fixed storage 120), such as a solid-state drive, hard disk drive, an optical drive, solid state drive, or other storage medium.

The network interface 116 may provide a direct connection to a remote server (e.g., server 140, database 150, remote platform 160, and/or remote user device 170 shown in FIG. 18) via a wired or wireless connection (e.g., network 130 shown in FIG. 18). The network interface 116 may provide such connection using any suitable technique and protocol as will be readily understood by one of skill in the art, including digital cellular telephone, WiFi, Bluetooth®, near-field, and the like. For example, the network interface 116 may allow the mobile robot 100 to communicate with other computers via one or more local, wide-area, or other communication networks, as described in further detail below. The mobile robot may transmit data via the network interface to the remote user device, including data and/or images from the sensors, audio signal generated from sound captured by the microphone, and the like.

Many other devices or components (not shown) may be connected in a similar manner. Conversely, all of the components shown in FIG. 17 need not be present to practice the present disclosure. The components can be interconnected in different ways from that shown. Code to implement the present disclosure can be stored in computer-readable storage media such as one or more of the memory 118, fixed storage 120, or on a remote storage location.

FIG. 18 shows an example network arrangement according to an implementation of the disclosed subject matter. The mobile robot 100 described above, and/or a similar mobile robot 200, may connect to other devices via network 130. The network 130 may be a local network, wide-area network, the Internet, or any other suitable communication network or networks, and may be implemented on any suitable platform including wired and/or wireless networks. The mobile robot 100 and/or mobile robot 200 may communicate with one another, and/or may communicate with one or more remote devices, such as server 140, database 150, remote platform 160, remote user device 170, and/or remote user device 180. The remote user device 170, 180 may be devices used by a user to control the operation of mobile robot 100, 200. The remote devices may directly access and/or be accessible to the mobile robot 100, 200 or one or more other devices may provide intermediary access, such as where a server 140 provides access to resources stored in a database 150. The mobile robot 100, 200 may access and/or be accessible to remote platform 160 or services provided by remote platform 160 such as cloud computing arrangements and services. The remote platform 160 may include one or more servers 140 and/or databases 150. The remote user device 170, 180 may control mobile robot 100, 200 and/or receive sensor data, one or more images, audio signals and the like via the network 130. The remote user device 170, 180 may transmit one or more images, video, commands, audio signals, and the like to the mobile robot 100, 200.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as solid state drives, DVDs, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may include using hardware that has a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving, at a mobile robot, one or more first control signals via a communications interface to control a drive system of the mobile robot to move within an area in a first operation mode;
transmitting, via the communications interface, image data captured by an image sensor of the mobile robot;
receiving, at the mobile robot, one or more second control signals via the communications interface to operate in a second mode to stop the movement of the mobile robot;
adjusting, at a controller of the mobile robot based on one or more third control signals received via the communications interface, a position of at least one selected from the group consisting of: text, an image, and video on a display screen of a display mounted to the mobile robot based on the captured image data when the captured image data includes one or more persons within the area; and
outputting the at least one of the text, the image, and the video at the adjusted position in the display screen of the display and audio via a speaker of the mobile robot to the one or more persons.

2. The method of claim 1, further comprising:
receiving, at the mobile robot, one or more third control signals via the communications interface to control the drive system of the mobile robot to move within the area in the first operation mode when the outputting the at least one of the text, the image, and the video is completed.

3. The method of claim 1, wherein the adjusting the position of the at least one of the text, the image, and the video in the display screen comprises:
adjusting, at the controller based on the one or more third control signals, the position of the at least one of the text, the image, and the video based on an average eye height of the one or more persons in the captured image data.

4. The method of claim 1, wherein the adjusting the position of the at least one of the text, the image, and the video in the display screen comprises:
detecting, at the image sensor or at least one other sensor, a height of at least one of the one or more persons;
transmitting, at the communications interface, the detected height of the one or more persons; and
adjusting, at the controller based on the one or more third control signals, the position of the at least one of the text, the image, and the video in the display screen based on the detected height of the at least one of the one or more persons.

5. The method of claim 4, wherein the detecting the height of at least one of the one or more persons comprises:
determining, at the controller, that the height of the at least one of the one or more persons is seated when the detected height is less than a predetermined height.

6. The method of claim 4, further comprising:
periodically detecting, at the image sensor or at least one other sensor, a change in the height of at least one of the one or more persons;
transmitting, at the communications interface, the detected height of the one or more persons; and
adjusting, at the controller based on the one or more third control signals, the position of the at least one of the text, the image, and the video from a first position to a second position in the display screen based on the detected change in the height of the at least one of the one or more persons.

7. The method of claim 6, wherein the adjusting the position comprises:
smoothly transitioning, at the display screen as controlled by the controller, between the output of the at least one of the text, the image, and the video from the first adjusted position to the second adjusted position to prevent visible jumping between the at least one of the text, the, image, and the video displayed at the first position and the second position.

8. The method of claim 1, wherein adjusting the position of the at least one of the text, the image, and the video in the display screen comprises:
adjusting, at the controller based on the one or more third control signals, the position of the at least one of the text, the image, and the video in the display screen based on a lowest eye height of the one or more persons in the captured image data.

9. The method of claim 1, further comprising:
capturing, at the image sensor, movement of the one or more persons in the area;
transmitting, at the communications interface, the image data of the captured movement; and
receiving, at the communications interface, the one or more third control signals to adjust the position of the at least one of the text, the image, and the video in the display screen of the display based on the captured movement of the one or more persons.

10. The method of claim 1, wherein the adjusting the position of the at least one of the text, the image, and the video in the display screen comprises:
determining, at the controller of the mobile robot, whether a distance between the mobile robot and the one or more persons is within a predetermined distance based on an output signal from one or more sensors of the mobile robot;
transmitting, at the communications interface, the determined distance; and
adjusting, at the controller based on the one or more third control signals, the position of the at least one of the text, the image, and the video in the display screen of the display when the one or more persons are determined to be within the predetermined distance from the mobile robot.

11. The method of claim 1, wherein the adjusting the position of the image or the video in the display screen comprises:
rescaling, based on the one or more third control signals, the at least one of the text, the image, and the video when the position of at least one of the text, the image, and the video in the display screen is adjusted.

12. The method of claim 1, wherein the adjusting the position of the at least one of the text, the image, and the video in the display screen comprises:
blocking or masking a portion of the display screen of the display that is separate from the position where the at least one of the text, the image, and the video is being displayed.

13. A method comprising:
receiving, at a mobile robot, one or more first control signals via a communications interface to control a drive system of the mobile robot to move within an area in a first operation mode;
determining, at a controller of the mobile robot, when there are one or more persons in the area using an image sensor communicatively coupled to the controller;
controlling, using the controller of the mobile robot, the drive system to stop the movement of the mobile robot within a predetermined distance of the one or more persons;
adjusting, at a controller of the mobile robot, a position of at least one selected from the group consisting of: text, an image, and video on a display screen of a display mounted to the mobile robot based on the captured image data when the captured image data includes one or more persons that are within the area; and
outputting, the at least one of the text, the image, and the video at the adjusted position in the display screen of the display and audio via a speaker of the mobile robot to the one or more persons.

14. The method of claim 13, further comprising:
receiving, at the mobile robot, one or more third control signals via the communications interface to control the drive system of the mobile robot to move within the area in the first operation mode when the outputting of the at least one of the text, the image, and the video is completed.

15. The method of claim 13, wherein the adjusting the position of the at least one of the text, the image, and the video in the display screen comprises:
adjusting, at the controller, the position of the at least one of the text, the image, and the video based on an average eye height of the one or more persons in the captured image data.

16. The method of claim 13, wherein the adjusting the position of the at least one of the text, the image, and the video in the display screen comprises:
detecting, at the image sensor or at least one other sensor, a height of at least one of the one or more persons; and
adjusting, at the controller, the position of the at least one of the text, the image, and the video in the display screen based on the detected height of the at least one of the one or more persons.

17. The method of claim 16, wherein the detecting the height of at least one of the one or more persons comprises:
determining, at the controller, that the height of the at least one of the one or more persons is seated when the detected height is less than a predetermined height.

18. The method of claim 16, further comprising:
periodically detecting, at the image sensor or at least one other sensor, a change in the height of at least one of the one or more persons; and
adjusting, at the controller, the position of the at least one of the text, the image, and the video from a first position to a second position in the display screen based on the detected change in the height of the at least one of the one or more persons.

19. The method of claim 18, wherein the adjusting the position comprises:
smoothly transitioning, at the display screen as controlled by the controller, between the output of the at least one of the text, the image, and the video from the first adjusted position to the second adjusted position to prevent visible jumping between the at least one of the text, the image, and the video displayed at the first position and the second position.

20. The method of claim 13, wherein adjusting the position of the at least one of the text, the image, and the video in the display screen comprises:
adjusting, at the controller, the position of the image or video in the display screen based on a lowest eye height of the one or more persons in the captured image data.

21. The method of claim 13, further comprising:
capturing, at the image sensor, movement of the one or more persons in the area; and
adjusting, at the controller, the position of the at least one of the text, the image, and the video in the display screen of the display based on the captured movement of the one or more persons.

22. The method of claim 13, wherein the adjusting the position of the at least one of the text, the image, and the video in the display screen comprises:
determining, at the controller of the mobile robot, whether a distance between the mobile robot and the one or more persons is within a predetermined distance based on an output signal from one or more sensors of the mobile robot;
adjusting, at the controller, the position of the at least one of the text, the image, and the video in the display screen of the display when the one or more persons are determined to be within the predetermined distance from the mobile robot.

23. The method of claim 13, wherein the adjusting the position of the at least one of the text, the image, and the video in the display screen comprises:
rescaling, at the controller, the at least one of the text, image and the video when the position of the at least one of the text, the image, and the video in the display screen is adjusted.

24. The method of claim 13, wherein the adjusting the position of the at least one of the text, the image, and the video in the display screen comprises:
blocking or masking a portion of the display screen of the display that is separate from the position where the at least one of the text, the image, and the video is being displayed.
